(19) United States
(12) Patent Application Publication
(10) Pub. No.: US 2026/0119893 A1
(43) Pub. Date: Apr. 30, 2026

(54) DIRECT KNOWLEDGE INJECTION INTO LARGE LANGUAGE MODELS USING A KEY-VALUE CACHE NETWORK LAYER

(71) Applicant: INTERNATIONAL BUSINESS MACHINES CORPORATION, ARMONK, NY (US)

(72) Inventors: Zhong Fang Yuan, Xi'an (CN); Yi Chen Zhong, Shanghai (CN); Xue Ping Liu, Beijing (CN); Tong Liu, Xi'an (CN)

(21) Appl. No.: 18/925,581

(22) Filed: Oct. 24, 2024

(51) Int. Cl. G06N 3/091; G06N 3/045

(52) U.S. Cl. CPC G06N 3/091; G06N 3/045

(57) ABSTRACT

Provided are techniques for direct knowledge injection into large language models using a key-value cache network layer. A Key-Value cache (KV-cache) network layer to a Large Language Model (LLM). A twin data distribution corresponding to the KV-cache network layer is updated by adding new data points. A Gaussian Mixture Model (GMM) is updated with the new data points based on the updated twin data distribution. The KV-cache network layer is updated with the new data points based on the Gaussian Mixture Model. A question is issued to the LLM, where the LLM generates an answer using the new data points of the updated KV-cache network layer. The answer to the question is received from the LLM.

### BACKGROUND

Embodiments of the invention relate to direct knowledge injection into large language models using a key-value cache network layer.

Currently, Large Language Models (LLMs) have been widely applied in various vertical industries. However, in the application of these LLMs in vertical industries, various issues, such as cognitive illusions, outdated knowledge, and incorrect prompts have emerged.

To address these challenges, the industry primarily employs techniques, such as Retrieval-Augmented Generation (RAG) or Fine-Tuning to infuse knowledge into the LLMs in an external or an internal way. However, these techniques also come with their respective drawbacks.

The RAG technique mainly utilizes retrieval recall combined with in-context learning prompts to supplement external knowledge for the LLM. The RAG technique may reduce cognitive illusions of large models, but typically does not completely eliminate such illusions, while its effectiveness is influenced by the accuracy of the retrieval process.

From instruction-tuning to Parameter-Efficient Fine-Tuning (PEFT) and Low-Rank Adaptation of Large Language Models (LoRA), the fine-tuning techniques may assist the LLM in updating the knowledge to address the phenomenon of cognitive illusions in vertical datasets. However, the fine-tuning techniques requires considerable coding skills and Graphics Processing Unit (GPU) hardware resources. Frontline business personnel who understand the data are often unable to take on this role.

The drawbacks of these two techniques determine that personnel most familiar with vertical industry knowledge (i.e., practitioners in the vertical industry) are not able to directly participate in the process of injecting and updating knowledge in the LLM.

Consequently, this injection and update is entrusted to data scientists or software engineers who are more familiar with LLM development. However, practitioners in these positions often lack an understanding of the vertical industry's data, leading to a dilemma and significant resource wastage.

### SUMMARY

In accordance with certain embodiments, a computer-implemented method comprising operations is provided for direct knowledge (i.e., data point) injection into large language models using a key-value cache network layer. In such embodiments, a Key-Value cache (KV-cache) network layer to a Large Language Model (LLM). A twin data distribution corresponding to the KV-cache network layer is updated by adding new data points. A Gaussian Mixture Model (GMM) is updated with the new data points based on the updated twin data distribution. The KV-cache network layer is updated with the new data points based on the Gaussian Mixture Model. A question is issued to the LLM, where the LLM generates an answer using the new data points of the updated KV-cache network layer. The answer to the question is received from the LLM.

In accordance with other embodiments, a computer program product comprising a computer readable storage medium having program code embodied therewith is provided, where the program code is executable by at least one computer processor to perform operations for direct knowledge injection into large language models using a key-value cache network layer. In such embodiments, a Key-Value cache (KV-cache) network layer to a Large Language Model (LLM). A twin data distribution corresponding to the KV-cache network layer is updated by adding new data points. A Gaussian Mixture Model (GMM) is updated with the new data points based on the updated twin data distribution. The KV-cache network layer is updated with the new data points based on the Gaussian Mixture Model. A question is issued to the LLM, where the LLM generates an answer using the new data points of the updated KV-cache network layer. The answer to the question is received from the LLM.

In accordance with yet other embodiments, a computer system comprises one or more computer processors, one or more computer-readable memories and one or more computer-readable, tangible storage devices; and program instructions, stored on at least one of the one or more computer-readable, tangible storage devices for execution by at least one of the one or more computer processors via at least one of the one or more memories, to perform operations for direct knowledge injection into large language models using a key-value cache network layer. In such embodiments, a Key-Value cache (KV-cache) network layer to a Large Language Model (LLM). A twin data distribution corresponding to the KV-cache network layer is updated by adding new data points. A Gaussian Mixture Model (GMM) is updated with the new data points based on the updated twin data distribution. The KV-cache network layer is updated with the new data points based on the Gaussian Mixture Model. A question is issued to the LLM, where the LLM generates an answer using the new data points of the updated KV-cache network layer. The answer to the question is received from the LLM.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment for a direct knowledge injection system in accordance with certain embodiments.

FIG. 3 illustrates direct injection of knowledge into an LLM and use of the LLM in accordance with certain embodiments.

FIG. 4 illustrates generation of a Key-Value cache (KV-cache) network layer in accordance with certain embodiments.

FIG. 5 illustrates a twin data distribution construction for the KV-cache network layer in accordance with certain embodiments.

FIG. 6 illustrates real-time knowledge insertion based on initially inserting data points into a twin data distribution in accordance with certain embodiments.

FIG. 7 illustrates a flow of operations from the twin data distribution, to a GMM, to the KV-cache network in accordance with certain embodiments.

FIG. 8 illustrates, in a flowchart, operations for direct knowledge injection in accordance with certain embodiments.

FIG. 9 illustrates, in a flowchart, operations for using an LLM with a KV-cache network layer in accordance with certain embodiments.

FIG. 10 illustrates, in a flowchart, operations for inserting data from the KV-cache network layer into the LLM in accordance with certain embodiments.

FIG. 11 illustrates, in a flowchart, operations for direct knowledge injection into a LLM using a key-value cache in accordance with certain embodiments.

FIG. 12 illustrates, in a block diagram, details of a machine learning model in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The description herein provides examples of embodiments of the invention, and variations and substitutions may be made in other embodiments. Several examples will now be provided to clarify various aspects of the present disclosure:

Example 1: A computer-implemented method comprises adding a Key-Value cache (KV-cache) network layer to a Large Language Model (LLM). The method further comprises updating a twin data distribution corresponding to the KV-cache network layer by adding new data points. The method further comprises updating a Gaussian Mixture Model (GMM) with the new data points based on the updated twin data distribution. The method further comprises updating the KV-cache network layer with the new data points based on the Gaussian Mixture Model. The method further comprises issuing a question to the LLM, wherein the LLM generates an answer using the new data points of the updated KV-cache network layer. The method further comprises receiving an answer to the question from the LLM.

Thus, embodiments advantageously enable direct knowledge (i.e., data point) injection to the LLM by adding new data points to the twin data distribution, updating the GMM with the updated twin data distribution, and updating the KV-cache network layer with the updated GMM. Then, the LLM advantageously has access to the new data points via the KV-cache network layer.

Example 2: The limitations of any of Examples 1 and 3-7, wherein the method further comprises constructing the KV-cache network layer with a key encoder transformer network, a value encoder transformer network, and a fully connected network. In this manner, embodiments advantageously enable use of the key encoder transformer network for keys, the value encoder transformer network for values, and the fully connected network to tie the keys and corresponding values together.

Example 3: The limitations of any of Examples 1-2 and 4-7, wherein the method further comprises training the KV-cache network layer with a joint training approach that uses a contrastive learning technique and loss combined with Instruct-tuning data from the LLM. In this manner, embodiments advantageously enable initially training the KV-cache network layer using data from the LLM.

Example 4: The limitations of any of Examples 1-3 and 5-7, wherein the method further comprises generating the GMM using the KV-cache network layer and generating the twin data distribution using the GMM. In this manner, embodiments advantageously generate the GMM and the twin data distribution so that the GMM and the twin data distribution may be used to inject the new data points into the LLM via the KV-cache network layer.

Example 5: The limitations of any of Examples 1-4 and 6-7, wherein the method further comprises determining that an amount of data points in the KV-cache network layer exceeds a data point threshold, using the data points in the KV-cache network layer as training data for supervised fine-tuning of the LLM, and reinitializing the KV-cache network layer. In this manner embodiments advantageously avoid the data point quantity of the KV-cache network layer increasing beyond a data point threshold as more data points are inserted into the KV-cache network layer.

Example 6: The limitations of any of Examples 1-5 and 7, wherein the KV-cache network layer is updated based on real-time insertion of the new data points, modification of existing data points, and deletion of the existing data points. In this manner, embodiments enable existing data points to be modified or deleted in addition to adding the new data points to the KV-cache network layer.

Example 7: The limitations of any of Examples 1-6, wherein the KV-cache network layer is positioned as part of the LLM. In this manner, embodiments advantageously enable constructing a foundational KV-cache network layer behind the original network layers of the LLM so that the KV-cache network layer may serve as an injection layer for new, modified, and deleted data points.

Example 8: A computer program product, the computer program product comprising one or more computer-readable storage media and program instructions stored on the one or more storage media to perform a method according to any one of Examples 1-7.

Example 9: A computer system, comprising a processor set, one or more computer-readable storage media, and program instructions stored on the one or more storage media to cause the processor set to perform a method according to any of Examples 1-7.

Example 10: The limitations of Examples 1, and 5, wherein embodiments advantageously enable reinitializing the KV-cache network layer to avoid the data point quantity of the KV-cache network layer increasing beyond a data point threshold as more data points are inserted into the KV-cache network layer. This advantageously ensures that the KV-cache network layer remains efficient as the amount of data points are limited to the data point threshold.

Example 11: The limitations of Examples 1 and 6, wherein embodiments enable existing data points to be modified or deleted in addition to adding the new data points to the KV-cache network layer. This advantageously ensures that the LLM has access to improved data points over time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

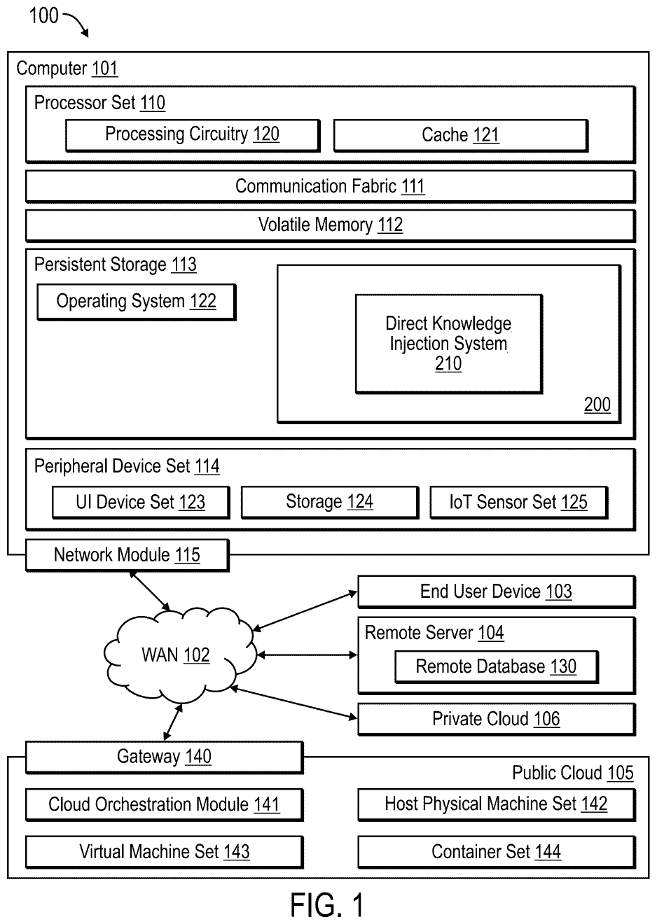

Computing environment 100 of FIG. 1 contains an example of an environment for the execution of at least some of the computer code involved in performing the inventive methods, such as direct knowledge injection system 210 of block 200. The knowledge may be described as one or more new data points, one or more modified data points, and/or one or more deleted data points. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services And/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

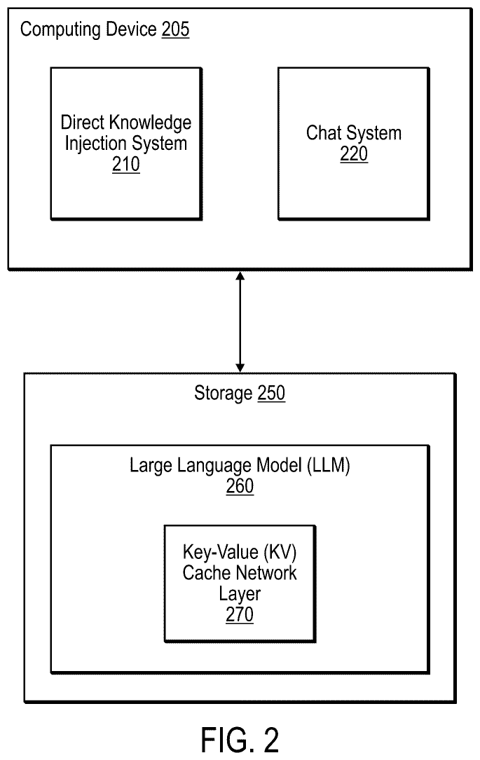

FIG. 2 illustrates a computing environment for a direct knowledge injection system 210 in accordance with certain embodiments. The knowledge is in the form of data points, which may also be called key-value pairs or parameters.

In FIG. 2, a computer 205 is connected to storage 250 (i.e., one or more storage devices). The computer 205 may have the components of computer 101. The computer 205 includes the direct knowledge injection system 210 and a chat system 220. The storage 250 (e.g., one or more storage devices) includes a Large Language Model (LLM) 260, which includes a Key-Value cache (KV-cache) network layer 270. The KV-cache network layer 270 may be described as a KV-cache.

The direct knowledge injection system 210 injects knowledge (i.e., one or more new data points, one or more modified data points, and/or one or more deleted data points) into the LLM 260 using the KV-cache network layer 270. Then, the chat system 220 enables using the LLM 260 to answer questions that reference the injected knowledge. Questions may be described as a type of prompt. In certain embodiments, the chat system 220 may receive a prompt form a user, submit that prompt to the LLM 260, receive an answer from the Although an LLM is referenced in the figures and text, embodiments are applicable to any model the receives prompts (e.g., questions) and provides answers (i.e., responses to the questions).

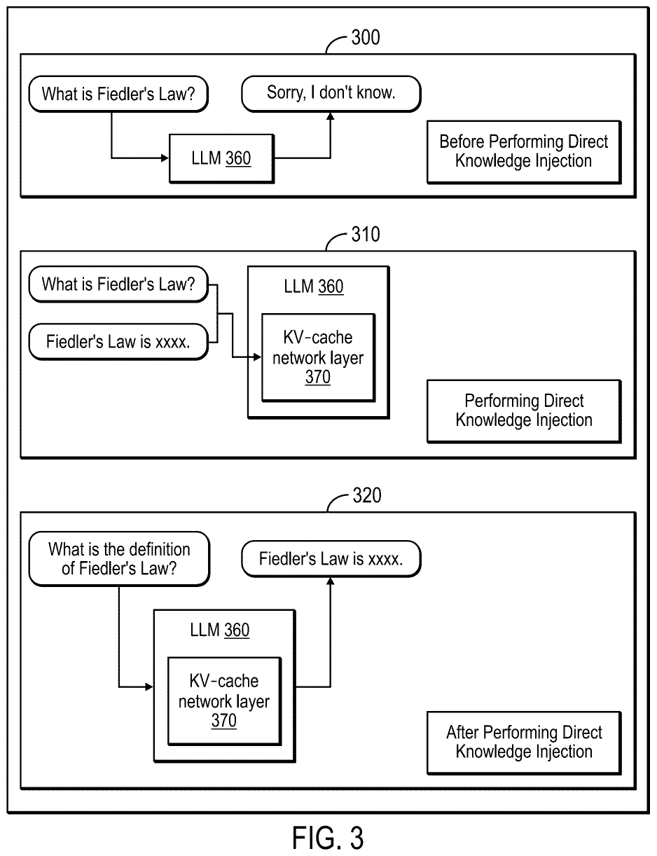

FIG. 3 illustrates direct injection of knowledge into the LLM 360 and use of the LLM 360 in accordance with certain embodiments. In box 300, before performing direct knowledge injection, the LLM 360 receives a question “What is Fiedler's Law” and outputs: “Sorry, I don't know”. LLM 360 is an example of LLM 260. In block 310, the direct knowledge injection system 210 injects the KV-cache network layer 370 with the key of “What is Fiedler's Law” and the value of “Fiedler's Law is xxx” to add new knowledge (i.e., a data point) of the key-value pair into the LLM 360. The KV-cache network layer 370 is an example of the KV-cache network layer 270. In block 320, the after performing direct knowledge injection, the LLM 360 receives a question “What is Fiedler's Law” and, using the KV-cache network layer 370, outputs: “Fiedler's Law is xxx”.

The direct knowledge injection system 210 allows for direct knowledge injection into the LLM 260 using natural language in the form of key-value pairs. This enables the direct injection of knowledge into the LLM 260 through direct teaching. In certain embodiments, a small amount of knowledge is injected into the LLM 260 at a given time. In various other embodiments, other amounts of knowledge are injected into the LLM 260 at a given time.

The direct knowledge injection system 210 constructs a KV-cache network layer 270 within the neural network layers of the LLM 260, then pre-trains the KV-cache network layer 270 to enable the capability of direct natural language insertion. The direct knowledge injection system 210 performs this training once. With embodiments, after the training, there is no need for further changes at the code or model levels by system administrators or other users.

This KV-cache network layer 270 within the neural network may be viewed as a KV-cache at the parameter level in the LLM 260. A parameter may also be referred to as a key-value pair or a data point. That is, the KV-cache network layer 270 may be referred to as a KV-cache or as a KV parameter cache. The direct knowledge injection system 210 simulates the binary knowledge group of key-value pairs using the prompt+answer technique (i.e., where the prompt may be a question), where the prompt is the input (i.e., question) to the LLM 260, and the answer is the output from the LLM 260.

After vectorizing this binary (i.e., key-value) knowledge group, the direct knowledge injection system 210 encodes the vectorized binary knowledge group into the post-connection network of the LLM 260. Vectorizing the key-value pair may include forming a vector for each word of the key and each word of the value. Encoding the vectorized binary knowledge group may be described as transforming the vectorized binary knowledge group into a format that the LLM 260 is able to understand and manipulate. As an analogy, the LLM 260 is like a traditional database embedded with a vast amount of knowledge, but making data changes may be relatively slow and challenging. On the other hand, the KV-cache network layer 270 is similar to a cache database at the mem-cache level, allowing for rapid addition, deletion, modification, and retrieval operations. The mem-cache may be described as an in-memory key-value store. The KV-cache network layer 270 is lightweight and more manageable to operate. With embodiments, these operations are performed in the form of tensors. A tensor may be described as a mathematical object that generalizes scalars, vectors, and matrices to higher dimensions. Tensors may be thought of as multidimensional arrays that represent data and may be manipulated using various mathematical operations.

Finally, the direct knowledge injection system 210 generates an LLM+ KV-cache network structure. The direct knowledge injection system 210 encodes (i.e., inserts) new knowledge into the KV-cache network layer 270 using the direct natural language teaching technique without altering the data points of the LLM 260 itself. When using the LLM 260, the direct knowledge injection system 210 also produces better knowledge output based on the knowledge in the KV-cache network layer.

The direct knowledge injection system 210 performs a technique that is different from conventional solutions, such as Generative Pre-trained Transformer (GPT) cache. While GPT cache and similar solutions are more akin to memory retrieval and follow a retrieval and matching approach, the direct knowledge injection system 210 is more akin to an externally integrated network hybrid access technique. The generated answers are not retrieved, but are entirely consistent with the LLM's 260 original generation technique.

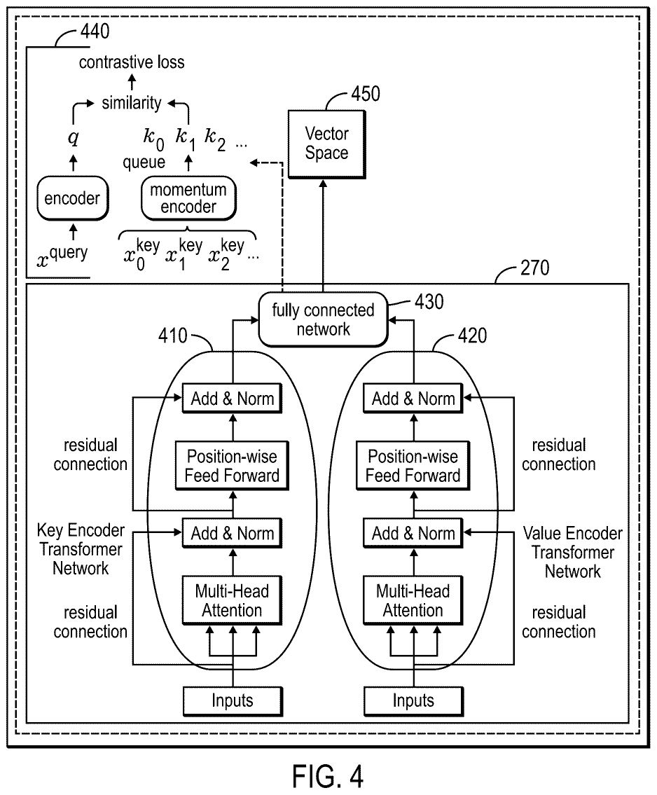

FIG. 4 illustrates generation of a KV-cache network layer 270 in accordance with certain embodiments. The direct knowledge injection system 210 constructs a foundational KV-cache network layer 270 behind the original network layers of the LLM 260. This KV-cache network layer 270 serves as an injection layer for knowledge and allows real-time insertion, modification, and deletion of knowledge in the subsequent operations.

The KV-cache network layer 270 is based on two transformer networks 410, 420 and one fully connected network 430. One transformer network 410 (i.e., a key encoder transformer network or a first transformer network) serves as the encoder for the keys in the knowledge, another transformer network 420 (i.e., a value encoder transformer network or a second transformer network) serves as the encoder for the values in the knowledge, and the fully connected network 430 acts as the bridging network between the key encoder transformer network 410 and the value encoder transformer network 420, responsible for the mapping relationship between the keys and values. In certain embodiments, the LLM 260 receives a question, matches the question to the key encoder transformer network 410 for a key, obtains the corresponding value from the value encoder transformer network 420, and returns the value as the answer to the question.

With encoding, the encoded representation for each word in the input captures the meaning and position of each word. The key encoder transformer network 410 receives inputs of the encoded representations of keys. The value encoder transformer network 420 receives inputs of the encoded representations of values. The multi-head attention processes the encoded representations to add an attention score to each encoded representation of each word. The first residual addition takes the embeddings before they were passed into the layer and adds them to the output, which enriches the embedding vectors with the information obtained from the multi-head attention layer. The first layer normalization maintains the mean and standard deviation of each embedding vector, or token, to help prevent issues with gradient descent. The position-wise feed-forward network (FFN) consists of two linear layers with a ReLU activation function between them, where the first layer has a higher dimensionality, and the second layer returns to the original dimensionality. The FFN enhances the expressive power of neural networks, allowing them to model complex functions and learn useful representations from the data. The second residual addition enriches the embedding vectors with the information obtained from the FFN, and the second layer normalization maintains the mean and standard deviation of each embedding vector, or token, to help prevent issues with gradient descent. The outputs of the key encoder transformer network 410 and the value encoder transformer network 420 go to the fully connected network 430, which generates the vector space 450. The fully connected network 430 also sends the outputs to block 440.

FIG. 4 may be described as illustrating an architecture used for contrastive learning, showing how encoders and a contrastive loss function are used to compute similarity. The encoder 442 of block 440 encodes the input data (labeled x^{query}) into a query vector q. The encoder 442 of block 440 maps the input data into a vector space, facilitating similarity comparison with other data points.

The momentum encoder 444 generates key vectors for the key samples. The momentum encoder 444 uses momentum updates to adjust its data points gradually, providing stability in encoding over time.

The queue of block 440 stores previously generated key vectors (labeled k0, k1, k2, . . . ). The key vectors are compared with the query vector q to compute similarity. By storing a large number of key vectors, the model effectively uses more negative samples, improving performance.

Contrastive loss may be described as a loss function that maximizes the similarity between the query vector q and positive key samples, while minimizing similarity with negative key samples. This is done by contrasting the query vector with multiple key vectors from the queue.

In this manner, FIG. 4 represents a contrastive learning process where the encoder 442 and the momentum encoder 444 generate query and key vectors, respectively. These vectors are used to calculate similarity, with contrastive loss optimizing the model by distinguishing between positive and negative samples in the queue.

During training, the direct knowledge injection system 210 adopts a joint training approach using a contrastive learning technique and loss combined with Instruct-tuning data from the LLM 260 to train the KV-cache network layer 270. Thus, with embodiments, the KV-cache network layer is initially trained using data from the LLM. The key encoder transformer network 410 uses the questions (i.e., keys) from the instruction data as training data, while the value encoder transformer network 420 uses the answers (i.e., values) from the instruction data as training data.

The contrastive learning technique may be described as a technique that emphasizes the extraction of significant representations from data by juxtaposing positive (similar) and negative (dissimilar) pairs of instances, where data that are similar are closely aligned in the embedding space, while data that are dissimilar are positioned further apart in the embedding space.

The loss combined with Instruct-tuning data may be described as Instruction Modelling (IM) that trains the LLM 260 by applying a loss function to the input (i.e., question or prompt) rather than solely to the output (i.e., answer).

In certain embodiments, the instruction data is used for Supervised Fine-Tuning (SFT) training of the LLM 260 and mainly consists of Question-Answer form data. The instruction data may be retrieved from, for example, open-source Question-Answer form data.

During training of the KV-cache network layer 270, the direct knowledge injection system 210 employs a contrastive learning approach and loss for the joint training of the network. The training involves encoding the key data and value data distributions through two transformer networks 410, 420, obtaining two initial vectors, and then using vector jittering in contrastive learning to generate a large number of positive samples. By mixing in inherent negative samples, the direct knowledge injection system 210 conducts contrastive learning training on the fully connected network. The aim is to ensure that the key data and value data, while maintaining a uniform distribution of key data and value data, are as close as possible in the vector space 450 for matching key and value.

Upon completion of training of the KV-cache network layer 270, the direct knowledge injection system 210 obtains a foundational KV-cache network layer 270 positioned in the back of the LLM 260. Then, the LLM 260 is highly sensitive to the matching or mapping relationship between questions and answers of the KV-cache network layer 270.

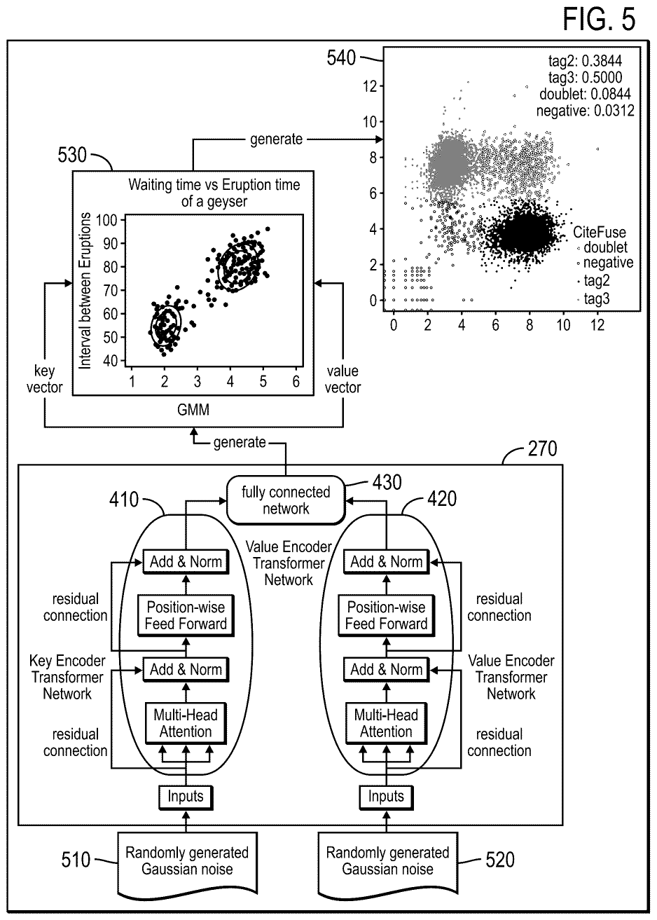

FIG. 5 illustrates a twin data distribution 540 construction for the KV-cache network layer 270 in accordance with certain embodiments. After training the foundational KV-cache network layer 270, the direct knowledge injection system 210 establishes the mapping relationship between Key and Value in the vector space.

First, based on the KV-cache network layer 270, the direct knowledge injection system 210 constructs a twin data distribution 540. This twin data distribution 540 represents the mathematical mapping of the KV-cache network layer in the vector space and is composed of a large number of data points. The direct knowledge injection system 210 uses this twin data distribution 540 for knowledge injection.

When constructing the twin data distribution 540, the direct knowledge injection system 210 utilizes the Gaussian Mixture Model (GMM) to fit the twin data distribution 540. The GMM is employed for modeling and processing complex data distributions, particularly suitable for multimodal distributions involved in embodiments. The GMM is advantageous in its ability to flexibly fit various data distributions of different shapes.

The direct knowledge injection system 210 performs the fitting technique is as follows:
1. Utilize a large amount of random Gaussian noise 510, 520 to generate corresponding vectors (key vectors and value vectors) through the key encoder transformer network 410 and the value encoder transformer network 420 of the KV-cache network layer.
2. Use key vectors as input and value vectors as output for dynamic GMM fitting, obtaining a GMM 530 that represents the KV-cache network layer.
3. Utilize the GMM 530 as a generator and employ the density estimation technique to generate data points for the twin data distribution 540 and store these data points in memory. These data points may be regarded as discrete fits of the GMM 530 and may also be seen as discrete fits of the KV-cache network layer 270. These data points are the data points of the vector space 450.

In certain embodiments, the density estimation technique may be described as the construction of an estimate, based on observed data, of an unobservable underlying probability density function, where the unobservable density function is thought of as the density according to which a large population is distributed.

The resulting data points may be considered as the twin data distribution 540 of the KV-cache network layer, which to a certain extent represents the KV-cache network layer, with the degree of approximation being directly proportional to the number of data points.

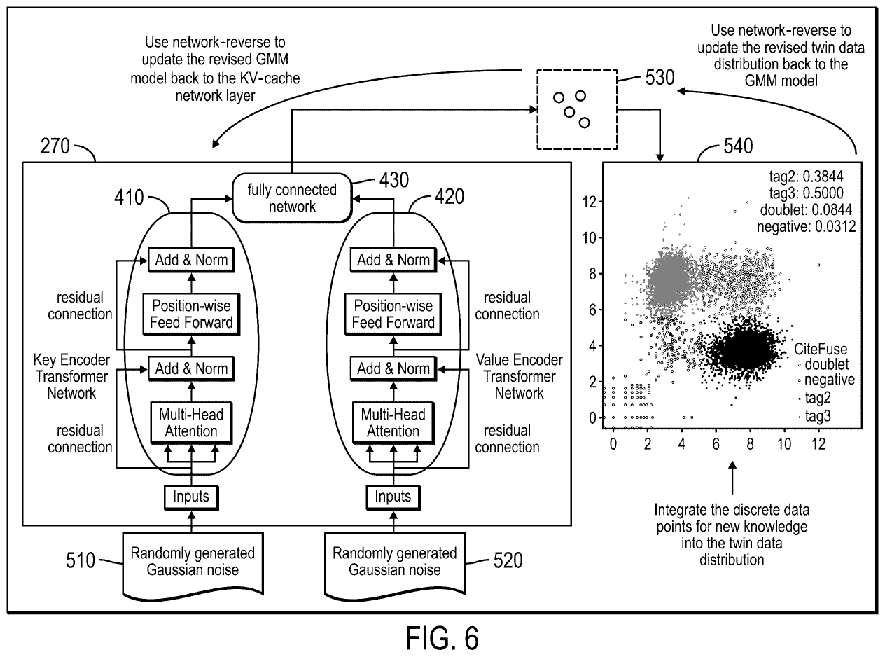

FIG. 6 illustrates real-time knowledge insertion based on initially inserting data points into a twin data distribution 540 in accordance with certain embodiments. Based on the KV-cache network layer 40 and with the aid of the GMM 530 as a bridging component, the direct knowledge injection system 210 acquires the twin data distribution 540 of the KV-cache network layer 270, which may be regarded as a discrete representation of the KV-cache network layer 270.

The direct knowledge injection system 210 utilizes this discrete representation to implement the operation of inserting new knowledge into the LLM 260. The direct knowledge injection system 210 performs the following operational technique:
1. Obtain (i.e., retrieve or identify) discrete data points for the knowledge to be inserted. In certain embodiments, this knowledge is inserted using the key encoder transformer network 410, the value encoder transformer network 420, the GMM 530, and the twin data distribution 540.
2. Integrate the discrete data points into the twin data distribution 540 of the KV-cache network layer 270.
3. Use network-reverse to update (i.e., reverse-update) the revised twin data distribution 540 back to the GMM 530 (e.g., by updating the data points of the GMM 530 based on the discrete data points updated in the twin data distribution 540), and then use network-reverse to update (i.e., reverse-update) the GMM 530 back to the KV-cache network layer 270 (e.g., by updating the key encoder transformer network 410 and the value encoder transformer network 420 with the key-value data of the discrete data points).
4. In this manner, the KV-cache network layer 270 is updated with new data. The process of real-time knowledge insertion is performed in real-time and exhibits high-speed performance. In a similar manner, data points in the twin data distribution 540 may be updated (i.e., modified) or deleted, and the changes to the data points are reverse-updated to the GMM 530 and then reverse-updated to the KV-cache network layer 270.

The updated KV-cache network layer 270 exists as an external network layer of the original LLM 260, storing knowledge updated in real-time.

In certain embodiments, the term “reverse-update” refers to the process of updating a model's data points or representations based on the results of a previous computation, effectively backtracking through the process that led to the current state of the model. In the context of updating the GMM 530 and the KV-cache network layer 270, “reverse-update” may be understood as follows:
1. Reverse-update to the GMM 530: This involves adjusting the data points of the GMM 530 based on the new data points integrated into the twin data distribution 540. The goal is to refine the ability of the GMM 530 to represent the relationships between keys and values in the KV-cache network layer 270 by incorporating the latest knowledge, ensuring that the GMM accurately reflects the current distribution of the data.
2. Reverse-update to the KV-cache network layer 270: This process entails modifying the data points of the KV-cache network layer 270 based on the updated GMM 530. By doing so, the KV-cache network layer 270 is aligned with the refined representations provided by the GMM 530, allowing for improved retrieval and integration of knowledge during operation by the LLM 260.

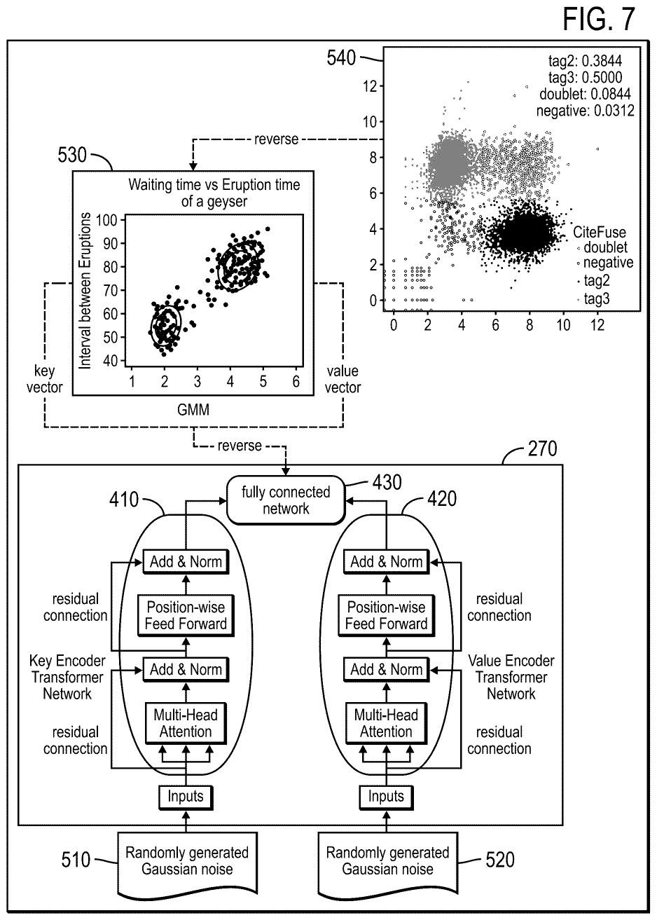

FIG. 7 illustrates a flow of operations from the twin data distribution 540, to a GMM, to the KV-cache network in accordance with certain embodiments. As can be seen, the flow starts with injecting new data points, modifying existing data points and/or deleting existing data points in the twin data distribution 540. The GMM 530 is updated based on the updates to the twin data distribution 540. The KV-cache network layer 270 is updated based on the updates to the GMM.

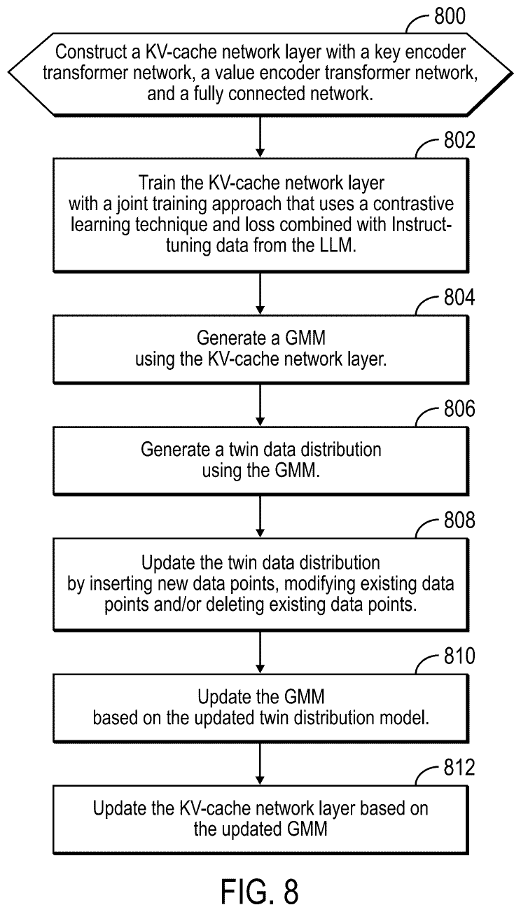

FIG. 8 illustrates, in a flowchart, operations for direct knowledge injection in accordance with certain embodiments. Control begins at block 800 with the direct knowledge injection system 210 constructing a KV-cache network layer 270 with a key encoder transformer network, a value encoder transformer network, and a fully connected network. In block 802, the direct knowledge injection system 210 training the KV-cache network layer 270 with a joint training approach that uses a contrastive learning technique and loss combined with Instruct-tuning data from the LLM 260.

In certain embodiments, blocks 800 and 802 involve encoding the key data and value data distributions through the through the key encoder transformer network and the value encoder transformer network, obtaining two initial vectors, and then using vector jittering in contrastive learning to generate a large number of positive samples. By mixing in inherent negative samples, contrastive learning training is conducted on the fully connected network.

In block 804, the direct knowledge injection system 210 generates a GMM using the KV-cache network layer 270. In block 806, the direct knowledge injection system 210 generates a twin data distribution using the GMM.

In certain embodiments, blocks 804 and 806 involve utilizing a large amount of random Gaussian noise to generate corresponding vectors (key vectors and value vectors) through the two encoder transformer networks (key and value) of the KV-cache network layer 270, using key vectors as input and value vectors as output for dynamic GMM fitting to obtain a GMM that represents the KV-cache network layer. Then, utilizing the GMM as a generator and employing the density estimation technique to generate data points for the twin data distribution, storing these data points in memory. These data points may be regarded as discrete fits of the GMM and may also be seen as discrete fits of the KV-cache network layer 270.

In block 808, the direct knowledge injection system 210 updates the twin data distribution by inserting new data points, modifying existing data points and/or deleting existing data points. In block 810, the direct knowledge injection system 210 updates the GMM based on the updated twin distribution model. In block 812, the direct knowledge injection system 210 updates the KV-cache network layer 270 based on the updated GMM. In this manner, new data is inserted into the KV-cache network layer 270.

In certain embodiments, blocks 808, 810, and 812 involve obtaining discrete data points for the data to be inserted, modified and/or deleted. Initially, the discrete data points are integrated into the twin data distribution corresponding to the KV-cache network layer 270. Then, network-reverse is used to update the revised twin data distribution back to the GMM, and then a network-reverse is used to update the KV-cache network layer 270.

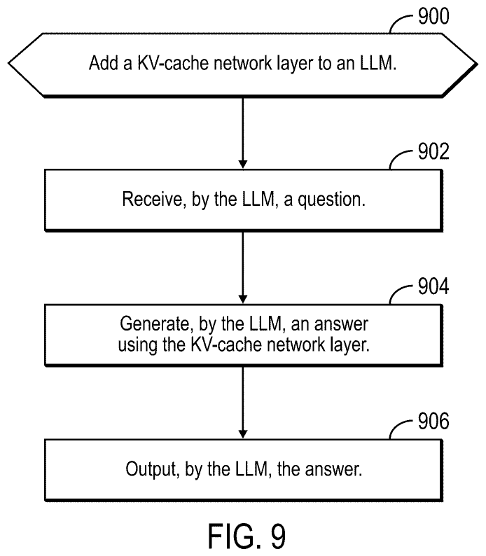

FIG. 9 illustrates, in a flowchart, operations for using an LLM with a KV-cache network layer in accordance with certain embodiments. Control begins at block 900 with the direct knowledge injection system 210 adding a KV-cache network layer 270 to an LLM 260. In block 902, the LLM 260 receives a question (e.g., from the direct knowledge injection system 210 or the chat system 220). In block 904, the LLM 260 generates an answer using the KV-cache network layer 270. In block 906, the LLM 260 outputs the answer (e.g., to the direct knowledge injection system 210 or the chat system 220).

In certain embodiments, the data point quantity of the KV-cache network layer 270 may gradually increase beyond a data point threshold as more knowledge in the form of data points are inserted into the KV-cache network. To overcome this, the direct knowledge injection system 210 sets up scheduled knowledge synchronization between the KV-cache network layer 270 and the LLM 260. In each real-time insertion, the direct knowledge injection system 210 accumulates the data. When a sufficient amount of data has been inserted (i.e., the amount of data exceeds the data point threshold), the direct knowledge injection system 210 uses this data as training data for supervised fine-tuning of the LLM 260, while also reinitializing the KV-cache network layer 270. Reinitializing the KV-cache network layer 270 may be described as removing the keys and values encoded in the transformer networks 410, 420 so that new data may be added to the KV-cache network layer 270.

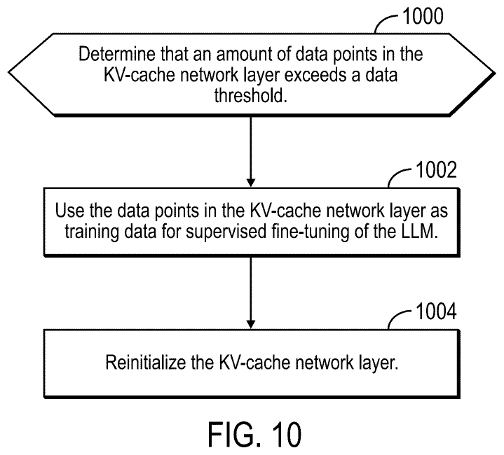

FIG. 10 illustrates, in a flowchart, operations for inserting data from the KV-cache network layer into the LLM in accordance with certain embodiments. Control begins at block 1000 with the direct knowledge injection system 210 determining that an amount of data points in the KV-cache network layer exceeds a data point threshold. In block 1002, the direct knowledge injection system 210 uses the data points in the KV-cache network layer as training data for supervised fine-tuning of the LLM. In block 1004, the direct knowledge injection system 210 reinitializes the KV-cache network layer.

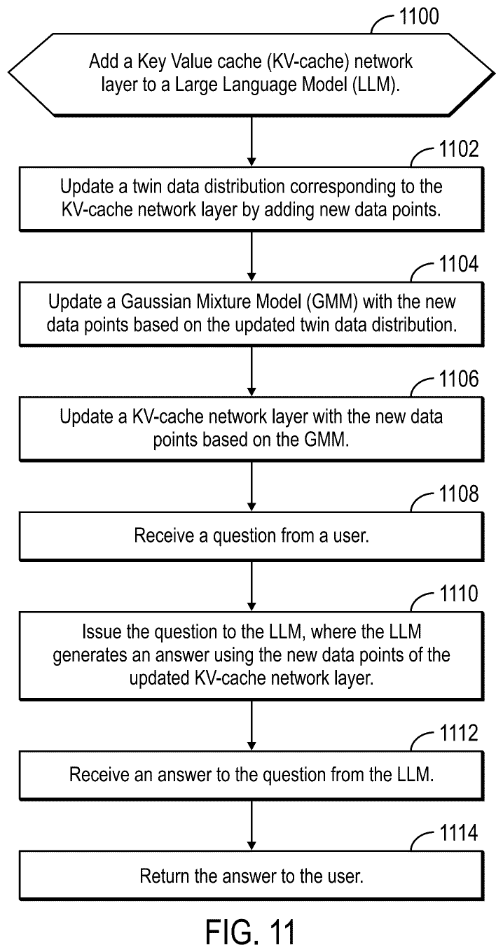

FIG. 11 illustrates, in a flowchart, operations for direct knowledge injection into a LLM using a key-value cache in accordance with certain embodiments.

Control begins at block 1100 with the direct knowledge injection system 210 adding a KV-cache network layer 270 to an LLM 260. In block 1102, the direct knowledge injection system 210 updates a twin data distribution corresponding to the KV-cache network layer by adding new data points. In block 1104, the direct knowledge injection system 210 updates a Gaussian Mixture Model (GMM) with the new data points based on the updated twin data distribution. In block 1106, the direct knowledge injection system 210 updates a KV-cache network layer with the new data points based on the GMM.

In block 1108, the direct knowledge injection system 210 or the chat system 220 receives a question from a user. In block 1110, the direct knowledge injection system 210 or the chat system 220 issues the question to the LLM, where the LLM generates an answer using the new data points of the updated KV-cache network layer. In block 1112, the direct knowledge injection system 210 or the chat system 220 receives an answer to the question from the LLM. In block 1114, the direct knowledge injection system 210 or the chat system 220 returns the answer to the user.

Thus, the direct knowledge injection system 210 directly injects new data points (i.e., new knowledge) into the LLM 260 and then uses the LLM 260 to answer questions pertaining to those new data points.

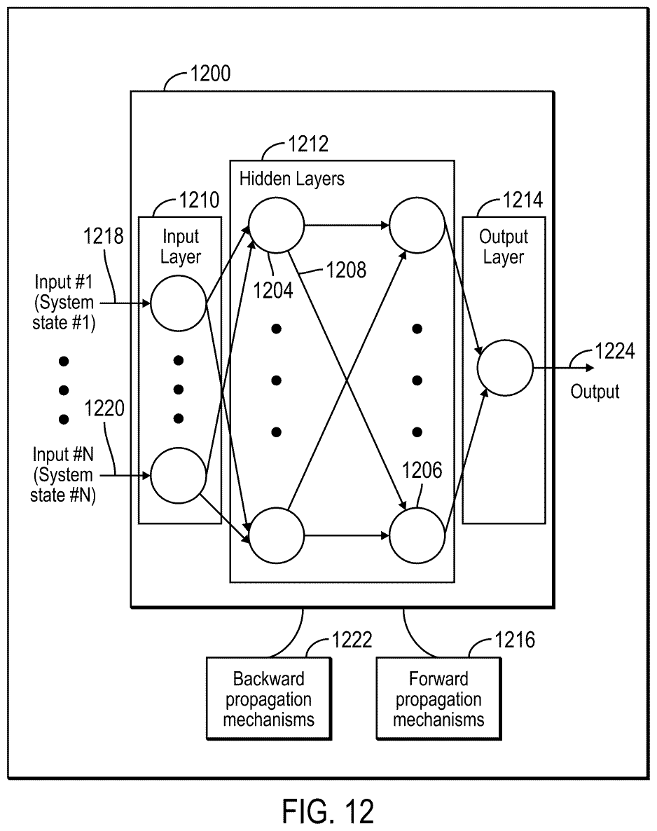

FIG. 12 illustrates, in a block diagram, details of a machine learning model 1200 in accordance with certain embodiments. In certain embodiments, the LLM 260 is implemented using the components of the machine learning model 1200.

The machine learning model 1200 may comprise a neural network with a collection of nodes with links connecting them, where the links are referred to as connections. For example, FIG. 12 shows a node 1204 connected by a connection 1208 to the node 1206. The collection of nodes may be organized into three main parts: an input layer 1210, one or more hidden layers 1212, and an output layer 1214.

The connection between one node and another is represented by a number called a weight, where the weight may be either positive (if one node excites another) or negative (if one node suppresses or inhibits another). Training the machine learning model 1200 entails calibrating the weights in the machine learning model 1200 via mechanisms referred to as forward propagation 1216 and backward propagation 1222.

Bias nodes that are not connected to any previous layer may also be maintained in the machine learning model 1200. A bias may be described as an extra input of 1 with a weight attached to it for a node.

In forward propagation 1216, a set of weights are applied to the input data 1218 . . . 1220 to calculate the output 1224. For the first forward propagation, the set of weights may be selected randomly or set by, for example, a system administrator. That is, in the forward propagation 1216, embodiments apply a set of weights to the input data 1218 . . . 1220 and calculate an output 1224.

In backward propagation 1222 a measurement is made for a margin of error of the output 1224, and the weights are adjusted to decrease the error. Backward propagation 1222 compares the output that the machine learning model 1200 produces with the output that the machine learning model 1200 was meant to produce, and uses the difference between them to modify the weights of the connections between the nodes of the machine learning model 1200, starting from the output layer 1214 through the hidden layers 1212 to the input layer 1210, i.e., going backward in the machine learning model 1200. In time, backward propagation 1222 causes the machine learning model 1200 to learn, reducing the difference between actual and intended output to the point where the two come very close or coincide.

The machine learning model 1200 may be trained using backward propagation to adjust weights at nodes in a hidden layer to produce adjusted output values based on the provided input data 1218 . . . 1220. A margin of error may be determined with respect to the actual output 1224 from the machine learning model 1200 and an expected output to train the machine learning model 1200 to produce the desired output value based on a calculated expected output. In backward propagation, the margin of error of the output may be measured and the weights at nodes in the hidden layers 1212 may be adjusted accordingly to decrease the error.

Backward propagation may comprise a technique for supervised learning of artificial neural networks using gradient descent. Given an artificial neural network and an error function, the technique may calculate the gradient of the error function with respect to the artificial neural network's weights.

Thus, the machine learning model 1200 is configured to repeat both forward and backward propagation until the weights of the machine learning model 1200 are calibrated to accurately predict an output.

The machine learning model 1200 implements a machine learning technique such as decision tree learning, association rule learning, artificial neural network, inductive programming logic, support vector machines, Bayesian models, etc., to determine the output 1224.

In certain machine learning model 1200 implementations, weights in a hidden layer of nodes may be assigned to these inputs to indicate their predictive quality in relation to other of the inputs based on training to reach the output 1224.

With embodiments, the machine learning model 1200 is a neural network, which may be described as a collection of “neurons”with “synapses”connecting them.

With embodiments, there may be multiple hidden layers 1212, with the term “deep” learning implying multiple hidden layers. Hidden layers 1212 may be useful when the neural network has to make sense of something complicated, contextual, or non-obvious, such as image recognition. The term “deep” learning comes from having many hidden layers. These layers are known as “hidden”, since they are not visible as a network output.

In certain embodiments, training a neural network may be described as calibrating all of the “weights” by repeating the forward propagation 1216 and the backward propagation 1222.

In backward propagation 1222, embodiments measure the margin of error of the output and adjust the weights accordingly to decrease the error.

Neural networks repeat both forward and backward propagation until the weights are calibrated to accurately predict the output 1224.

In certain embodiments, the input to the machine learning model 1200 is a question, and the output of the machine learning model 1200 is an answer. In certain embodiments, the machine learning model may be refined based on whether the outputted recommendations, once taken, generate positive outcomes.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)”unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method, comprising operations for:
adding a Key-Value cache (KV-cache) network layer to a Large Language Model (LLM);
updating a twin data distribution corresponding to the KV-cache network layer by adding new data points;
updating a Gaussian Mixture Model (GMM) with the new data points based on the updated twin data distribution;
updating the KV-cache network layer with the new data points based on the Gaussian Mixture Model;
issuing a question to the LLM, wherein the LLM generates an answer using the new data points of the updated KV-cache network layer; and
receiving the answer to the question from the LLM.

2. The computer-implemented method of claim 1, wherein the operations further comprise:
constructing the KV-cache network layer with a key encoder transformer network, a value encoder transformer network, and a fully connected network.

3. The computer-implemented method of claim 1, wherein the operations further comprise:
training the KV-cache network layer with a joint training approach that uses a contrastive learning technique and loss combined with Instruct-tuning data from the LLM.

4. The computer-implemented method of claim 1, wherein the operations further comprise:
generating the GMM using the KV-cache network layer; and
generating the twin data distribution using the GMM.

5. The computer-implemented method of claim 1, wherein the operations further comprise:
determining that an amount of data points in the KV-cache network layer exceeds a data point threshold;
using the data points in the KV-cache network layer as training data for supervised fine-tuning of the LLM; and
reinitializing the KV-cache network layer.

6. The computer-implemented method of claim 1, wherein the KV-cache network layer is updated based on real-time insertion of the new data points, modification of existing data points, and deletion of the existing data points.

7. The computer-implemented method of claim 1, wherein the KV-cache network layer is positioned as part of the LLM.

8. A computer program product comprising:
one or more computer-readable storage media; and
program instructions stored on the one or more storage media to perform operations comprising:
adding a Key-Value cache (KV-cache) network layer to a Large Language Model (LLM);
updating a twin data distribution corresponding to the KV-cache network layer by adding new data points;
updating a Gaussian Mixture Model (GMM) with the new data points based on the updated twin data distribution;
updating the KV-cache network layer with the new data points based on the Gaussian Mixture Model;
issuing a question to the LLM, wherein the LLM generates an answer using the new data points of the updated KV-cache network layer; and
receiving the answer to the question from the LLM.

9. The computer program product of claim 8, wherein the operations further comprise:
constructing the KV-cache network layer with a key encoder transformer network, a value encoder transformer network, and a fully connected network.

10. The computer program product of claim 8, wherein the operations further comprise:
training the KV-cache network layer with a joint training approach that uses a contrastive learning technique and loss combined with Instruct-tuning data from the LLM.

11. The computer program product of claim 8, wherein the operations further comprise:
generating the GMM using the KV-cache network layer; and
generating the twin data distribution using the GMM.

12. The computer program product of claim 8, wherein the operations further comprise:
determining that an amount of data points in the KV-cache network layer exceeds a data point threshold;
using the data points in the KV-cache network layer as training data for supervised fine-tuning of the LLM; and
reinitializing the KV-cache network layer.

13. The computer program product of claim 8, wherein the KV-cache network layer is updated based on real-time insertion of the new data points, modification of existing data points, and deletion of the existing data points.

14. The computer program product of claim 8, wherein the KV-cache network layer is positioned as part of the LLM.

15. A computer system comprising:
a processor set;
one or more computer-readable storage media; and
program instructions stored on the one or more storage media to cause the processor set to perform operations comprising:
adding a Key-Value cache (KV-cache) network layer to a Large Language Model (LLM);
updating a twin data distribution corresponding to the KV-cache network layer by adding new data points;
updating a Gaussian Mixture Model (GMM) with the new data points based on the updated twin data distribution;
updating the KV-cache network layer with the new data points based on the Gaussian Mixture Model;
issuing a question to the LLM, wherein the LLM generates an answer using the new data points of the updated KV-cache network layer; and
receiving the answer to the question from the LLM.

16. The computer system of claim 15, wherein the operations further comprise:
constructing the KV-cache network layer with a key encoder transformer network, a value encoder transformer network, and a fully connected network.

17. The computer system of claim 15, wherein the operations further comprise:
training the KV-cache network layer with a joint training approach that uses a contrastive learning technique and loss combined with Instruct-tuning data from the LLM.

18. The computer system of claim 15, wherein the operations further comprise:
generating the GMM using the KV-cache network layer; and
generating the twin data distribution using the GMM.

19. The computer system of claim 15, wherein the operations further comprise:
determining that an amount of data points in the KV-cache network layer exceeds a data point threshold;
using the data points in the KV-cache network layer as training data for supervised fine-tuning of the LLM; and
reinitializing the KV-cache network layer.

20. The computer system of claim 15, wherein the KV-cache network layer is updated based on real-time insertion of the new data points, modification of existing data points, and deletion of the existing data points.
